(19) United States
(12) Patent Application Publication
(10) Pub. No.: US 2017/0114179 A1
(43) Pub. Date: Apr. 27, 2017

(54) POLYISOCYANATE COMPOSITION, COATING COMPOSITION AND COATING METHOD

(71) Applicant: ASAHI KASEI KABUSHIKI KAISHA, Tokyo (JP)

(72) Inventors: Masakazu YAMAUCHI, Tokyo (JP); Changfeng HONG, Tokyo (JP)

(73) Assignee: ASAHI KASEI KABUSHIKI KAISHA, Tokyo (JP)

(21) Appl. No.: 15/332,144

(22) Filed: Oct. 24, 2016

(30) Foreign Application Priority Data
Oct. 27, 2015 (JP) 2015-211173

(51) Int. Cl. C08G 18/73; C08G 18/32; C09D 175/04

(52) U.S. Cl. CPC C08G 18/73; C09D 175/04; C08G 18/3206

(57) ABSTRACT

The present invention provides a polyisocyanate composition comprising a composition obtained at least from an aliphatic diisocyanate, a diol and a monoalcohol, wherein an average number of an isocyanate group is 3.8 or more to 10.0 or less

### BACKGROUND OF THE INVENTION

Field of the Invention

The present invention relates to a polyisocyanate composition, a coating composition and a coating method.

Description of the Related Art

A polyurethane resin coating material is known to have excellent abrasion resistance, chemical resistance and stain resistance; in particular, a polyurethane resin coating material using a non-yellowing polyisocyanate derived from hexamethylene diisocyanate or isophorone diisocyanate further has excellent weatherability. Accordingly, such a polyisocyanate is variously used, in a form of a normal-temperature-curable or heat-curable two-pack urethane coating material, for construction, heavy-duty coating, vehicles and industries, and for repairing purposes in these fields. In the respective purposes of use, the improvement of the curability of polyisocyanate has been desired, for example, in order to shorten the process involved.

As a method for improving the curability, for example, there is a method in which an organotin compound is added to a composition; however, this method has problems such that the improvement effect of the curability varies depending on the composition of the coating material, and such an additive adversely affects the combustion catalyst used in the disposal device of the organic solvent volatilizing in the step of coating or the like.

For the purpose of solving the above-described problems, the development of a multi-functional polyisocyanate is underway. For example, Patent Literature 1 proposes to obtain a multi-functional polyisocyanate by an isocyanuration after the reaction of at least one type of aliphatic or alicyclic diisocyanate with a multifunctional alcohol, or by an isocyanuration of an aliphatic or alicyclic diisocyanate in the presence of such an alcohol.

### CITATION LIST

### Patent Literature

[Patent Literature 1]: Japanese Patent Laid-Open No. 6-293878

### SUMMARY OF THE INVENTION

### Problems to be Solved by the Invention

However, such a polyisocyanate as described in Patent Literature 1 still has room for improvement in the compatibility with a compound (hereinafter, also referred to as an “active hydrogen compound”) having in the molecule thereof two or more active hydrogen atoms having reactivity with the isocyanate group of the polyol being a main component or the like, and room for improvement in the concealing property of the foundation surface.

Accordingly, an object of the present invention is to provide a polyisocyanate composition excellent in the curability based on the reaction with an active hydrogen compound (hereinafter, also simply referred to as “curability”), and excellent in the concealing property of the foundation surface (hereinafter, also simply referred to as the “foundation concealing property”). Here, “the concealing property of the foundation surface” means the property for smoothing the irregularities in the portion serving as the foundation when a curable composition including a polyisocyanate is applied thereto.

### Means for Solving the Problems

The present inventors made a diligent study in order to solve the above-described problems of the prior art, and have perfected the present invention by discovering that a polyisocyanate composition being obtained at least from an aliphatic diisocyanate, a diol and a monoalcohol and having a predetermined functional group in a specific proportion is excellent in the curability and the foundation concealing property.

Specifically, the present invention has the following constitution.

[1]

A polyisocyanate composition comprising a composition obtained at least from an aliphatic diisocyanate, a diol and a monoalcohol, wherein an average number of an isocyanate group is 3.8 or more to 10.0 or less.

[2]

The polyisocyanate composition according to [1], wherein a molar ratio of an allophanate group to a total amount of an isocyanurate group and the allophanate group is 0.20 or more to 0.90 or less.

[3]

The polyisocyanate composition according to [1], wherein a molar ratio of an allophanate group to a total amount of a urethane group and the allophanate group is 0.60 or more to 1.00 or less.

[4]

The polyisocyanate composition according to [1], wherein the average number of the isocyanate group is 4.0 or more to 10.0 or less.

[5]

The polyisocyanate composition according to [1], wherein a viscosity at 25° C. is 8000 mPa·s or more to 50000 mPa·s or less.

[6]

The polyisocyanate composition according to [1], wherein a content of the isocyanate group is 14.0% by mass or more to 21.0% by mass or less.

[7]

The polyisocyanate composition according to [1], wherein a number of carbon atoms in the monoalcohol is 4 or more to 10 or less.

[8]

The polyisocyanate composition according to [1], wherein a molar ratio of an allophanate group to a total amount of the allophanate group and a urethane group is 0.60 or more to 1.00 or less, and the average number of the isocyanate group is 4.0 or more to 10.0 or less.

[9]

The polyisocyanate composition according to [1], wherein a molar ratio of an allophanate group to a total amount of the allophanate group and a urethane group is 0.60 or more to 1.00 or less, and a viscosity at 25° C. is 8000 mPa·s or more to 50000 mPa·s or less.

[10]

The polyisocyanate composition according to [1], wherein a molar ratio of an allophanate group to a total amount of the allophanate group and a urethane group is 0.60 or more to 1.00 or less, the average number of the isocyanate group is 4.0 or more to 10.0 or less, and a viscosity at 25° C. is 8000 mPa·s or more to 50000 mPa·s or less.

[11]

A coating composition comprising the polyisocyanate composition according to [1] and a polyol.

[12]

A coating method comprising a step of applying the coating composition according to [11] to a base coat including a pigment.

### Advantageous Effects of Invention

The polyisocyanate composition according to the present invention is excellent in the curability and at the same time in the foundation concealing property.

### DETAILED DESCRIPTION OF THE PREFERRED EMBODIMENTS

Hereinafter, the mode for carrying out the present invention (hereinafter, simply referred to as the “present embodiment”) is described in detail. The following present embodiment is an exemplification for describing the present invention, and is not intended to limit the present invention to the following contents. The present invention can be implemented as appropriately modified within the scope of the gist thereof.

### [Polyisocyanate Composition]

The polyisocyanate composition of the present embodiment includes the composition obtained at least from an aliphatic diisocyanate, a diol and a monoalcohol, wherein the average number of the isocyanate group is 3.8 or more to 10.0 or less. The polyisocyanate composition of the present embodiment is excellent both in the curability and in the compatibility with an active hydrogen compound (hereinafter, also simply referred to as the “compatibility”), and further displays an excellent foundation concealing property.

In the polyisocyanate composition, the molar ratio of the allophanate group to the total amount of the isocyanurate group and the allophanate group (hereinafter, referred to as the molar ratio of “allophanate group/(isocyanurate group+allophanate group)”) is 0.20 or more to 0.90 or less, and the molar ratio of the allophanate group to the total amount of the allophanate group and the urethane group (hereinafter, referred to as the molar ratio of “allophanate group/(allophanate group+urethane group)”) is 0.60 or more to 1.00 or less.

In the polyisocyanate composition, the molar ratio of allophanate group/(isocyanurate group+allophanate group) is 0.20 or more to 0.90 or less. The lower limit of the aforementioned molar ratio is preferably 0.25 and more preferably 0.30. On the other hand, the upper limit of the aforementioned molar ratio is preferably 0.80 and more preferably 0.70. When the molar ratio of allophanate group/(isocyanurate group+allophanate group) is 0.20 or more, the polyisocyanate composition is excellent in the compatibility. When the molar ratio of allophanate group/(isocyanurate group+allophanate group) is 0.90 or less, the polyisocyanate composition tends to be improved in hardness, and consequently is excellent in the curability.

The molar ratio between the allophanate group and the isocyanurate group can be determined by measurement of ¹H-NMR. Specifically, when 1,6-hexamethylene diisocyanate (hereinafter also referred to as a “HDI”) is used as the aliphatic diisocyanate, the molar ratio between the isocyanurate group and the allophanate group can be determined by measuring the ratio between the area (corresponding to 2H) of the signal around 3.85 ppm of the hydrogen atoms of the methylene group originating from HDI and adjacent to the isocyanurate group and the area (corresponding to 1H) of the signal around 8.50 ppm of the hydrogen atom bonded to the nitrogen atom of the allophanate bond. Specifically, the aforementioned ratio can be determined on the basis of the method described in below-described Examples.

In the polyisocyanate composition, the molar ratio of allophanate group/(allophanate group+urethane group) is 0.60 or more to 1.00 or less. The lower limit of the aforementioned molar ratio is preferably 0.70, more preferably 0.75 and further preferably 0.80. Herein, the allophanate group is formed from the isocyanate group of the diisocyanate and the urethane group. The diisocyanate group and the hydroxyl group of the diol form the urethane group. In other words, the molar ratio of allophanate group/(allophanate group+urethane group) is an index indicating the proportion of the hydroxyl group of the diol, transformed up to the allophanate group. The molar ratio in the case where the hydroxyl group originating from the diol is completely allophanated is 1.00, and accordingly the upper limit of the aforementioned molar ratio is 1.00. When the molar ratio of allophanate group/(allophanate group+urethane group) is 0.60 or more, the polyisocyanate composition exhibits an excellent compatibility and an excellent curability.

The molar ratio between the allophanate group and the urethane group can be determined by measurement of ¹H-NMR. Specifically, when HDI is used as the aliphatic diisocyanate, the molar ratio of allophanate group/(allophanate group+urethane group) can be determined by measuring the area (1H) of the signal around 8.50 ppm of the hydrogen atom bonded to the nitrogen atom of the allophanate bond and the area (1H) of the signal around 4.90 ppm of the hydrogen atom bonded to the nitrogen atom of the urethane bond, and by deriving the ratio between these areas. Specifically, the aforementioned ratio can be determined on the basis of the method described in below-described Examples.

The average number of the isocyanate group in the polyisocyanate composition is 3.8 or more to 10.0 or less. The average number of the isocyanate group is preferably 4.0 or more, more preferably 4.2 or more and further preferably 4.5 or more. When the average number of the isocyanate group in the polyisocyanate is 3.8 or more, the polyisocyanate is excellent in the curability and the drying property when a coating composition is prepared by using the polyisocyanate. In addition, when the average number of the isocyanate group is 3.8 or more, the cross-linking density tends to be increased and the weatherability tends to be enhanced. On the other hand, the average number of the isocyanate group is preferably 8.0 or less, more preferably 6.5 or less and further preferably 5.5 or less. When the average number of the isocyanate group in the polyisocyanate composition is 10.0 or less, the exterior appearance of the coating film is excellent when the coating composition is prepared by using the polyisocyanate composition. The average number of the isocyanate group can be determined on the basis of the method described in below-described Examples.

Examples of the method for obtaining a polyisocyanate composition having the average number of the isocyanate group falling within the above-described range include, without being particularly limited to: the increase of the conversion rate of the isocyanuration reaction, specifically in such a way that the conversion rate is set at 30% by mass or more, preferably 35% by mass or more and more preferably 40% by mass or more; and moreover, the increase of the molar ratio of allophanate group/(allophanate group+urethane group) originating from the diol used, specifically in such a way that the aforementioned molar ratio is set at a high value of 0.6 or more, preferably 0.7 or more and more preferably 0.75 or more.

The content of the isocyanate group in the polyisocyanate composition is preferably 14.0% by mass or more to 21.0% by mass or less. The lower limit of the content of the isocyanate group is more preferably 15.0% by mass, further preferably 16.0% by mass and furthermore preferably 17.0% by mass. The upper limit of the content of the isocyanate group is more preferably 20.5% by mass and further preferably 20.0% by mass. When the content of the isocyanate group is 14.0% by mass or more, the polyisocyanate composition tends to have a viscosity allowing the composition to be more easily handled. When the concentration of the isocyanate group is 21.0% by mass or less, the curability of the coating composition tends to be more satisfactory. The content of the isocyanate group can be measured on the basis of the method described in below-described Examples.

The viscosity of the polyisocyanate composition at 25° C. is the viscosity as measured with an E-type viscometer, and is preferably 8000 mPa·s or more to 50,000 mPa·s or less. The lower limit of the viscosity is more preferably 9000 mPa·s and further preferably 10000 mPa·s. The upper limit of the viscosity is more preferably 40000 mPa·s, further preferably 30000 mPa·s and furthermore preferably 20000 mPa·s. The polyisocyanate composition of the present embodiment can include, in addition to the aliphatic diisocyanate, the volatile components such as an alicyclic diisocyanate and a solvent; however, the above-described viscosity is defined as the value obtained by measuring the polyisocyanate composition purified so as to have a solid content concentration of 98% by mass or more, and more specifically, the above-described viscosity can be measured by the method described in below-described Examples. When the viscosity is 8000 mPa·s or more, the above-described average number of the isocyanate group can be set to be higher, and the curability of the coating composition tends to be satisfactory. When the viscosity is 50000 mPa·s or less, the compatibility tends to be more satisfactory. The viscosity can be determined on the basis of the method described in below-described Examples.

The concentration of the isocyanate cyclic trimer in the polyisocyanate composition is preferably 10.0% by mass or more to 30.0% by mass or less. The lower limit of the aforementioned concentration is more preferably 12.0% by mass and further preferably 14.0% by mass. The upper limit of the aforementioned concentration is more preferably 28.0% by mass, further preferably 26.0% by mass and furthermore preferably 25.0% by mass. When the aforementioned concentration is 10% by mass or more, the compatibility tends to be more satisfactory. When the aforementioned concentration is 30% by mass or less, the curability of the coating composition tends to be more satisfactory. The concentration of the isocyanate cyclic trimer can be determined by GPC measurement. Specifically, the aforementioned concentration can be measured by the method described in below-described Examples. It is to be noted that the isocyanate cyclic trimer is typically the isocyanurate composed of three molecules of diisocyanate. The concentration of the isocyanate cyclic trimer can be determined on the basis of the method described in below-described Examples.

The number average molecular weight Mn of the polyisocyanate composition is not particularly limited, but is preferably 700 or more to 1200 or less and more preferably 800 or more to 1100 or less. When the number average molecular weight is 700 or more, the average number of the isocyanate group tends to be increased, and when the number average molecular weight is 1200 or less, the viscosity of the obtained polyisocyanate composition tends to be able to be maintained low. In order to obtain a polyisocyanate composition having a number average molecular weight of 700 or more to 1200 or less, while the monoalcohol and the diol are being added in predetermined amounts, the yield may be set at 40% by mass to 60% by mass. The number average molecular weight can be measured by the method described in below-described Examples.

The solid content concentration of the polyisocyanate composition is not particularly limited, but is preferably 98.0% by mass or more and more preferably 99.0% by mass or more, based on the total amount (100% by mass) of the polyisocyanate composition. When the solid content concentration is 98.0% by mass or more, the odor of the HDI monomer or the like tends to be able to be suppressed. In order to obtain a polyisocyanate composition having a solid content concentration of 98.0% by mass or more, the low boiling point fraction may be removed, in the purification step, after the synthesis of the polyisocyanate composition. The solid content concentration can be measured by the method described in below-described Examples.

### <Diisocyanate>

The aliphatic diisocyanate of the present embodiment is not particularly limited, but is preferably aliphatic diisocyanates having 4 or more to 30 or less carbon atoms. Specific examples of the aliphatic diisocyanate include, without being limited to, the following: 1,4-butane diisocyanate, 1,5-pentane diisocyanate, 1,6-hexamethylene diisocyanate, 2,2,4-trimethyl-hexamethylene-1,6-diisocyanate and lysine diisocyanate. Preferable among these are 1,5-pentane diisocyanate (hereinafter, referred to as “PDI”) and 1,6-hexamethylene diisocyanate (hereinafter, referred to as “HDI”) because these tend to result in a satisfactory weatherability and a satisfactory reactivity, and the viscosities of the polyisocyanate compositions obtained by using these tend to be low. These aliphatic diisocyanates may be used each alone or in combinations.

Together with the aliphatic diisocyanate of the present embodiment, other diisocyanates may also be used. Examples of the other diisocyanates include, without being particularly limited to: alicyclic diisocyanates and aromatic diisocyanates.

### <Diol>

The polyisocyanate composition of the present embodiment preferably has an allophanate group and a urethane group. As the hydroxyl group-containing compounds constituting the allophanate group and the urethane group in the polyisocyanate composition, part of the polyisocyanate composition is constituted with diol units, from the viewpoint of making satisfactory the compatibility with the active hydrogen compound and the curability when the coating composition is prepared from the polyisocyanate composition. The diol unit means the part originating from the diol constituting part of the polyisocyanate. The hydroxyl groups of a diol react with the isocyanate group, and during this reaction, substantially no eliminated substances occur. Accordingly, the diol fed as a starting material undergoes no reduction of the mass, and constitutes part of the polyisocyanate.

Examples of the diol include, without being limited to, the following: linear aliphatic diols such as ethylene glycol, 1,3-propanediol, 1,2-propanediol, 1,3-butanediol, 1,4-butanediol, 2,3-butanediol, 1,5-pentanediol, 1,2-pentanediol, 1,3-pentanediol, 1,4-pentanediol, neopentyl glycol, 1,6-hexanediol, 1,7-heptanediol, 1,8-octanediol, 1,9-nonanediol, 1,10-decanediol, diethylene glycol, polyethylene glycol, polypropylene glycol, and polytetramethylene glycol; and branched aliphatic diols such as 2-methyl-1,3-propanediol, 3-methyl-1,5-pentanediol, 2-methyl-1,8-octanediol and 2,2-diethyl-1,3-propanediol. These may be used each alone or in combinations of two or more thereof. Among these, the lower limit of the number of the carbon atoms of the diol is preferably 2, more preferably 3 and further preferably 4. When the number of the carbon atoms of the diol is 2 or more, the average number of the isocyanate group is high, and the curability and the drying property tend to be more satisfactory. On the other hand, the upper limit of the number of the carbon atoms of the diol is preferably 10, more preferably 8, further preferably 6 and furthermore preferably 5. When the number of the carbon atoms of the diol is 10 or less, the compatibility is more satisfactory, and the exterior appearance of the coating film tends to be further improved.

The mass concentration (content) of the diol unit constituting the polyisocyanate composition of the present embodiment is not particularly limited, but is preferably 1.0% by mass or more to 20.0% by mass or less, based on the total amount (100% by mass) of the polyisocyanate composition. The lower limit of the content is more preferably 2.0% by mass, further preferably 3.0% by mass, furthermore preferably 4.0% by mass and still furthermore preferably 5.0% by mass. On the other hand, the upper limit of the content is more preferably 18.0% by mass, further preferably 15.0% by mass and furthermore preferably 10.0% by mass. When the content of the diol component is 1.0% by mass or more, the compatibility with the active hydrogen compound being a main component is satisfactory, and when the concentration of the diol component is 20.0% by mass or less, the coating film more excellent in weatherability tends to be able to be obtained. The concentration of the diol component can be calculated from the yield and the feed composition of the obtained polyisocyanate composition.

### <Monoalcohol>

Part of the polyisocyanate composition of the present embodiment is constituted with a monoalcohol unit. The monoalcohol unit means the part originating from the monoalcohol constituting part of the polyisocyanate. The hydroxyl group of the monoalcohol reacts with the isocyanate group, and during this reaction, no eliminated substances occur. Accordingly, the monoalcohol fed as a starting material undergoes nearly no reduction of the mass, and constitutes part of the polyisocyanate.

The monoalcohol is preferably a compound having an aliphatic group and having no aromatic group in the structure thereof. Examples of such a monoalcohol include, without being particularly limited to: ethanol, 1-propanol, 2-propanol, 1-butanol, 2-methyl-1-propanol, 2-butanol, 1-pentanol, 3-methyl-1-butanol, 2-methyl-1-butanol, 2,2-dimethyl-1-propanol, 2-pentanol, 3-methyl-2-butanol, 3-pentanol, 2-methyl-2-butanol, 1-hexanol, 2-methyl-1-pentanol, 3-methyl-1-pentanol, 4-methyl-1-pentanol, 2,2-dimethyl-1-butanol, 2-ethyl-1-butanol, 2-hexanol, 3-hexanol, 3-methyl-2-pentanol, 4-methyl-2-pentanol, 2-methyl-3-pentanol, 3,3-dimethyl-2-butanol, 1-heptanol, 2-heptanol, 3-heptanol, 4-heptanol, 1-octanol, 6-methyl-1-heptanol and 2-ethyl hexanol. Preferable among these are the monoalcohols having a branch and being primary alcohols such as 2-methyl-1-propanol, 3-methyl-1-butanol, 2-methyl-1-butanol, 2-methyl-1-pentanol, 3-methyl-1-pentanol, 4-methyl-1-pentanol, 2-ethyl-1-butanol and 2-ethyl hexanol; and further preferable are 2-methyl-1-propanol and 2-ethylhexanol. The monoalcohols are used each alone or in combinations of two or more thereof.

The number of the carbon atoms of the monoalcohol is preferably 4 or more to 10 or less. The upper limit of the number of the carbon atoms of the monoalcohol is more preferably 9, further preferably 8, furthermore preferably 6 and still furthermore preferably 5. When the number of the carbon atoms is 4 or more, the NCO content (% by mass) can be maintained high, and the curability tends to be more satisfactory. When the number of the carbon atoms is 10 or less, the compatibility tends to be more satisfactory. From the viewpoint of more effectively and certainly achieving the operation and effect due to the present embodiment, the monoalcohol is more preferably a primary alcohol, and further preferably further has a branched structure.

In the polyisocyanate, the mass concentration (content) of the monoalcohol unit is preferably 0.05% by mass or more to 10.0% by mass or less. The lower limit of the content is more preferably 0.10% by mass, further preferably 0.15% by mass and furthermore preferably 0.20% by mass. The upper limit of the content is more preferably 5.00% by mass, further preferably 2.50% by mass and furthermore preferably 1.00% by mass. When the content of the monoalcohol unit is 0.05% by mass or more, the compatibility with the active hydrogen compound being a main component of the polyisocyanate tends to be satisfactory, and when the content of the monoalcohol unit is 10% by mass or less, the curability based on the reaction with the active hydrogen compound being a main component of the polyisocyanate tends to be higher.

The hydroxyl group of the monoalcohol preferably reacts with the isocyanate group to form the allophanate bond.

When the reaction is allowed to occur under the condition that the amount of the isocyanate group is largely excessive as compared with the amount of the hydroxyl group, in general the hydroxyl group of the monoalcohol and the isocyanate group of the diisocyanate monomer react with each other, thus the average number of the isocyanate group of the polyisocyanate forming the allophanate bond comes to be 2, and accordingly the curability of the polyisocyanate including such isocyanate groups tends to be low. Surprisingly, nonetheless, even when such a monoalcohol is used as a starting material, a polyisocyanate having a high curability has been able to be obtained.

### [Method for Producing Polyisocyanate Composition]

Next, an example of the method for producing the polyisocyanate composition of the present embodiment is described, but the production method is not limited to the following.

The method for producing a polyisocyanate composition preferably includes a step of allowing the isocyanate group of the above-described aliphatic diisocyanate and the hydroxyl groups of a diol and a monoalcohol to react with each other (for urethanization). In this case, the reaction temperature can be set to be 50° C. or higher to 150° C. or lower. The lower limit of the reaction temperature is more preferably 60° C. and further preferably 70° C. The upper limit of the reaction temperature is more preferably 130° C., further preferably 110° C. and furthermore preferably 90° C. When the reaction temperature is 50° C. or higher, the urethanization reaction tends to easily proceed, and when the reaction temperature is 150° C. or lower, the coloration of the obtained polyisocyanate composition tends to be reduced. The reaction time preferably falls within a range of 0.5 hour or more to 24 hours or less. The upper limit of the reaction time is more preferably 10 hours, further preferably 5.0 hours and furthermore preferably 3.0 hours.

The method for producing the polyisocyanate composition preferably includes a step of allowing the reaction to proceed (for isocyanuration and/or allophanation) after having allowed part or the whole of the hydroxyl groups of the diol and the monoalcohol to react with the isocyanate group of the diisocyanate. As the method for producing the polyisocyanate composition of the present embodiment, the above-described step for the urethanization reaction and the above-described step for the allophanation reaction and/or the isocyanuration reaction may be performed one after another, or may be performed simultaneously; however, after the formation of the urethane bond through the reaction between the isocyanate group of the diisocyanate and the hydroxyl groups of the diol and the monoalcohol, simultaneously with the isocyanuration reaction, the allophanation and/or isocyanuration reaction is preferably performed. These reactions can be appropriately allowed to proceed through the selection of the isocyanuration reaction catalyst and the reaction conditions. When the reaction is allowed to proceed with a catalyst, the reaction temperature of the isocyanuration or the allophanation is preferably 60° C. or higher to 150° C. or lower. The lower limit of the reaction temperature is more preferably 65° C. and further preferably 70° C. The upper limit of the reaction temperature is more preferably 130° C., further preferably 110° C. and furthermore preferably 90° C. When the reaction temperature is 60° C. or higher, the allophanation reaction tends to proceed easily, and the molar ratio of allophanate group/(allophanate group+urethane group) tends to be high. When the reaction temperature is 150° C. or lower, the coloration of the obtained polyisocyanate composition tends to be more reduced. The reaction time of the isocyanuration or the allophanation is preferably 1.0 hour or more to 10 hours or less. The upper limit of the reaction time is more preferably 8.0 hours, further preferably 6.0 hours and furthermore preferably 5.0 hours. When the reaction time is 1.0 hour or more, the isocyanuration rate and the allophanation rate tend to be higher. When the reaction time is 10 hours or less, the coloration tends to be more reduced.

The isocyanuration catalyst and the allophanation catalyst usable in the foregoing description are not particularly limited, but are preferably catalysts having basicity. Specific examples of the catalyst include, without being limited to, the following: (i) hydroxides and salts of weak organic acids such as acetic acid and capric acid of tetraalkylammoniums such as tetramethylammonium and tetraethylammonium; (ii) hydroxides and salts of weak organic acids such as acetic acid and capric acid of hydroxyalkylammoniums such as trimethylhydroxypropylammonium, trimethylhydroxyethylammpnium, triethylhydroxypropylammonium and triethylhydroxyethylammonium; (iii) salts of metals such as tin, zinc and lead of alkylcarboxylic acids such as acetic acid, caproic acid, octylic acid and myristic acid; (iv) alcoholates of metals such as sodium and potassium; (v) aminosilyl group-containing compounds such as hexamethyl disilazane; (vi) Mannich bases; (vii) combination of tertiary amines and epoxy compounds; and (viii) phosphorus-based compounds such as tributylphosphine. Preferable among these are hydroxides and salts of organic weak acids of tetraalkylammoniums. These catalysts may be added either collectively or successively.

In order to terminate these reactions, the catalysts can be deactivated. When the catalysts are neutralized and thereby deactivated, for example, phosphoric acid, acidic substances such as phosphoric acid and acidic phosphoric acid esters can be added. Alternatively, the catalysts can also be deactivated by thermal decomposition or chemical decomposition. Additionally, the catalysts can be deactivated by being adsorbed on activated charcoal, alumina or the like and by being taken outside the reaction system.

The yield of the polyisocyanate composition (the mass of the obtained polyisocyanate composition/the total mass of the fed starting materials×100) is preferably 20% by mass or more to 70% by mass or less. The lower limit of the yield is more preferably 30% by mass, further preferably 40% by mass and furthermore preferably 45% by mass. The upper limit of the yield is more preferably 65% by mass and further preferably 60% by mass. When the yield is 20% by mass or more, the average number of the isocyanate group tends to able to be higher, and when the yield is 70% by mass or less, the viscosity of the obtained polyisocyanate tends to be able to be lower. The yield can be determined on the basis of the method described in below-described Examples.

After the completion of the reaction, the unreacted diisocyanate monomer can be removed, for example, by using a thin film evaporation can or by extraction. The concentration of the unreacted diisocyanate monomer in the obtained polyisocyanate composition is preferably 2.0% by mass or less, more preferably 1.0% by mass or less, further preferably 0.5% by mass or less and furthermore preferably 0.3% by mass or less. When the concentration of the unreacted diisocyanate monomer is 2.0% by mass or less, the curability tends to be more satisfactory. The concentration of the unreacted diisocyanate monomer can be determined on the basis of the method described in below-described Examples.

### [Coating Composition]

Next, the coating composition including the polyisocyanate composition of the present embodiment is described. In other words, the coating composition of the present embodiment includes the polyisocyanate composition of the present embodiment and a polyol. The coating composition of the present embodiment can be constituted, for example, by mixing the polyisocyanate composition obtained as described above and a compound including in the molecule thereof two or more active hydrogen atoms having the reactivity with the isocyanate group. These constituent components react with each other to form a cross-linked coating film.

Examples of the above-described compound including in the molecule thereof two or more active hydrogen atoms include, without being limited to, if a polyol is at least included, the following: polyols, and additionally polythiols; two or more of these compounds may also be used in combination. Specific examples of the polyol include, without being particularly limited to: polyester polyol, acrylic polyol, polyether polyol, polyolefin polyol, fluoropolyol, polycarbonate polyol and polyurethane polyol.

Examples of the polyester polyol include, without particularly limited to: polyester polyols obtained from the condensation reaction between a single dibasic acid selected from or a mixture of dibasic acids selected from the carboxylic acid group consisting of succinic acid, adipic acid, sebacic acid, dimer acid, maleic acid anhydride, phthalic acid anhydride, isophthalic acid and terephthalic acid and a single polyhydric alcohol selected from or a mixture of polyhydric alcohols selected from the group consisting of ethylene glycol, propylene glycol, diethylene glycol, neopentyl glycol, trimethylolpropane and glycerin; and polycaprolactones obtained by ring opening polymerization of ε-caprolactone using a polyhydric alcohol.

The acrylic polyol is not particularly limited, but is obtained, for example, by copolymerizing a single ethylenically unsaturated bond-containing monomer having a hydroxyl group or a mixture of ethylenically unsaturated bond-containing monomers each having a hydroxyl group with another single ethylenically unsaturated bond-containing monomer or a mixture of other ethylenically unsaturated bond-containing monomers.

Examples of the polyether polyols include, without being particularly limited to: polyether polyols obtained by adding, to a single polyhydric hydroxy compound or a mixture of polyhydric hydroxy compounds, a single alkylene oxide or a mixture of alkylene oxides selected from alkylene oxides such as ethylene oxide, propylene oxide, butylene oxide, cyclohexene oxide and styrene oxide, by using a strongly basic catalyst selected from hydroxides of lithium, sodium and potassium, and alcoholates, alkylamines and the like; polyether polyols obtained by allowing alkylene oxides to react with multifunctional compounds such as ethylene diamines; and so-called polymer polyols obtained by polymerizing acrylic amides and the like by using these polyether polyols as media.

Examples of the polyolefin polyol include, without being particularly limited to: polybutadiene having two or more hydroxyl groups, hydrogenated polybutadiene, polyisoprene and hydrogenated polyisoprene. The statistic number of the hydroxyl groups possessed by one molecule (the average number of the hydroxyl groups) of a polyol is preferably 2.0 or more. When the average number of hydroxyl groups of the polyol is 2.0 or more, the decrease of the cross-linkage density of the obtained coating film tends to be able to be suppressed.

A fluoropolyol is a polyol containing fluorine in the molecule thereof; examples of the fluoropolyol include: without being particularly limited to: copolymers of fluoroolefins, cyclovinyl ethers, hydroxyalkyl vinyl ether, monocarboxylic acid vinyl esters and the like disclosed in Japanese Patent Laid-Open No. 57-34107 and Japanese Patent Laid-Open No. 61-275311.

Examples of the polycarbonate polyols include, without being particularly limited to: polycarbonate polyols obtained by polycondensation of low-molecular-weight carbonate compounds such as dialkyl carbonates such as dimethyl carbonate, alkylene carbonates such as ethylene carbonate and diaryl carbonates such as diphenyl carbonate with low-molecular-weight polyols used for the above-described polyester polyols.

Polyurethane polyols are not particularly limited, but can be obtained, for example, by allowing polyols and polyisocyanate to react with each other.

The hydroxyl value per resin of a polyol is preferably 10 mg KOH/resin g or more to 300 mg KOH/resin g or less. When the hydroxyl value per resin is 10 mg KOH/resin g, the decrease of the cross-linkage density is suppressed, and thus the properties intended in the present embodiment tend to be able to be achieved sufficiently. On the other hand, when the hydroxyl value per resin is 300 mg KOH/resin g or less, the excessive increase of the cross-linkage density is suppressed, and thus the mechanical properties of the coating film tend to be maintained to a high degree.

The acid value per resin of a polyol is preferably 5.0 mg KOH/resin g or more to 150 mg KOH/resin g or less, more preferably 8.0 mg KOH/resin g or more to 120 mg KOH/resin g or less and further preferably 10 mg KOH/resin g or more to 100 mg KOH/resin g or less. When the acid value is 5.0 mg KOH/resin g or more, the aqueous dispersibility tends to be able to be maintained high, and when the acid value is 150 mg KOH/resin g or less, the degradation of the water resistance of the coating film tends to be able to be suppressed.

Among the above-listed polyols, acrylic polyol and polyester polyol are more preferable. When a coating composition is prepared by using the polyisocyanate composition of the present embodiment, the equivalent ratio between the isocyanate group of the polyisocyanate composition and the hydroxyl group of the polyol is preferably appropriately selected from the range from 1/2 to 2/1.

As the polyamine as referred to herein, polyamines each having two or more of primary amino groups or secondary amino groups in one polyamine molecule are preferably used, and among such polyamines, polyamines each having three or more primary amino groups or secondary amino groups are more preferable.

The alkanolamine as referred to herein means a compound having an amino group and a hydroxyl group in one molecule of the compound. Examples of the alkanolamine include, without being particularly limited to: monoethanolamine, diethanolamine, aminoethylethanolamine, N-(2-hydroxypropyl)ethylenediamine, mono-, di-(n- or iso-) propanolamine, ethylene glycol-bis-propylamine, neopentanolamine and methylethanolamine.

According to the application and the purpose of the coating composition, the following can be mixed in the coating composition: various solvents; ultraviolet absorbers such as benzotriazole and benzophenone; light stabilizers such as hindered amines and hindered phenols; organic pigments such as quinacridone, pigment red and phthalocyanine blue; inorganic pigments such as titanium oxide and carbon black; metallic pigment such as aluminum powder; light interference pigments such as pearl mica powder; curing promoters such as tin compounds, zinc compounds and amine compounds. The solvent is not limited to the following, but can be used by appropriately selecting according to the purpose and application from the group consisting of the following: ketones such as acetone, methyl ethyl ketone and methyl isobutyl ketone; esters such as ethyl acetate, n-butyl acetate and cellosolve acetate; and alcohols such as butanol and isopropyl alcohol. These solvents may be used each alone or in combinations of two or more thereof.

For the coating composition prepared as described above, the coating methods such as roll coating, curtain flow coating and spray coating can be used; the coating composition is preferably applied so as to result in a dry film thickness of 10 μm or more to 100 μm or less. The coating composition is preferably used as a vehicle repair coating material or a plastic coating material.

The coating composition of the present embodiment is also preferably used for clear coat.

### [Coating Method]

The coating method of the present embodiment includes a step of applying the coating composition of the present embodiment to the pigment-containing base coat. Here, as the pigment, the above-described organic pigments, inorganic pigments, metallic pigments, light interference pigments and the like can be appropriately used.

### EXAMPLES

Hereinafter, the present embodiment is described in more detail on the basis of Examples; however, the present embodiment is not limited to following Examples. It is to be noted that unless otherwise specified, “parts” and “%” represent parts by mass and % by mass, respectively. First, for the respective properties and the respective evaluations, the following measurement methods and evaluation standards are described.

### (Property 1) Number Average Molecular Weight

The number average molecular weight of the polyisocyanate composition was determined as the number average molecular weight relative to polystyrene standards by the gel permeation chromatography (hereinafter, referred to as “GPC”) measurement using the following apparatus and conditions.

Apparatus: “HLC-8120GPC” (trade name) manufactured by Tosoh Corp.

Columns: manufactured by Tosoh Corp.
“TSKgel SuperH1000” (trade name)×1
“TSKgel SuperH2000” (trade name)×1
“TSKgel SuperH3000” (trade name)×1

Carrier: Tetrahydrofuran

Detection method: Differential refractometer

Sample concentration: 5 wt/vol %,

Flow rate: 0.6 mL/min,

Column temperature: 30° C.

### (Property 2) Yield

The yield of the polyisocyanate composition was calculated from the following formula.

Yield (%)=(Mass of obtained polyisocyanate composition/total mass of fed starting materials)×100

### (Property 3) Isocyanate Group Content (% by Mass)

The isocyanate content (NCO content, % by mass) in the polyisocyanate composition was determined by neutralizing the isocyanate group in the measurement sample with excessive 2N amine, and then performing back-titration with 1N hydrochloric acid. It is to be noted that the solid content concentrations of the polyisocyanate compositions prepared in below-described Examples and Comparative Examples were checked by the below-described method of (Property 5), and the compositions having a solid content concentration of 98% by mass or more were measured as they were.

### (Property 4) Average Number of Isocyanate Groups

The average number of the isocyanate group in the polyisocyanate composition was calculated from the number average molecular weight of the above-described (Property 1) and the content of the isocyanate group of the above-described (Property 3) on the basis of the following general formula.

$$Average number of isocyanate groups = \frac{\begin{matrix}( Number average molecular weight ) \times \\ ( content of isocyanate group ( \% by mass ) )\end{matrix}}{formula weight ( 42 ) of isocyanate \times 100} \qquad [ Expression 1 ]$$

(Property 5) Solid Content Concentration (% by mass)

After an aluminum plate having a bottom diameter of 38 mm was weighed accurately, the aluminum plate with each of polyisocyanate compositions of Examples or Comparative Examples placed thereon was weighed accurately (w1), then the polyisocyanate composition on the plate was regulated so as to have a uniform thickness, and the plate was maintained for 1 hour in an oven set at 105° C. After the aluminum plate was cooled to room temperature, the polyisocyanate composition remaining on the aluminum plate was weighed accurately (w2), and the solid content concentration (% by mass) was calculated from the following formula.

Solid content concentration=W2/W1×100

### (Property 6) Diisocyanate Monomer Concentration

The peak area (%) corresponding to the molecular weight (168 in the case of HDI) of the diisocyanate obtained in the GPC measurement of (Property 1) was determined as the mass concentration (content) of the diisocyanate monomer in the polyisocyanate composition.

### (Property 7) Isocyanate Cyclic Trimer Concentration

The concentration of the peak of the molecular weight (504 in the case of HDI) corresponding to the diisocyanate cyclic trimer obtained in the GPC measurement of (Property 1) was determined in terms of the area percentage thereof.

### (Property 8) Viscosity

The viscosity of each of the polyisocyanate compositions was measured by using an E-type viscometer (manufactured by Tokimec Inc.) at 25° C. In the measurement, a standard rotor (1°34′×R24) was used. The number of rotations was as follows.

100 rpm (in the case of less than 128 mPa·s)

50 rpm (in the case of 128 mPa·s or more to less than 256 mPa·s)

20 rpm (in the case of 256 mPa·s or more to less than 640 mPa·s)

10 rpm (in the case of 640 mPa·s or more to less than 1280 mPa·s)

5 rpm (in the case of 1280 mPa·s or more to less than 2560 mPa·s)

### (Property 9) Molar Ratios of Allophanate Group, Isocyanurate Group and Urethane Group

With the FT-NMR AVANCE 600 manufactured by Bruker Corp., by using heavy chloroform CDCl₃ as the solvent, at a sample (polyisocyanate composition) concentration of 5% by mass, at 600 MHz, with an accumulation number of 256, proton nuclear magnetic resonance spectra were measured, and the molar ratios of the allophanate group, the isocyanurate group and the urethane group were checked. With reference to the whole of the β-position and γ-position protons originating from HDI, for the isocyanurate group the area ratio of the signal around 3.85 ppm of the hydrogen atoms of the methylene group originating from HDI adjacent to the isocyanurate group, for the allophanate group the area ratio of the signal around 8.50 ppm of the hydrogen atom bonded to the nitrogen of the allophanate bond, and for the urethane group the area ratio of the signal around 4.90 ppm of the hydrogen atom bonded to the nitrogen of the urethane bond were measured, and the molar ratios 1 and 2 were determined on the basis of the following formulas.

Allophanate group/(allophanate group+isocyanurate group)=(signal area around 8.50 ppm)/(signal area around 8.50 ppm+signal area around 3.85 ppm/6) Molar ratio 1:

Allophanate group/(allophanate group+urethane group)=(signal area around 8.50 ppm)/(signal area around 8.50 ppm+signal area around 4.90 ppm) Molar ratio 2:

### (Property 10) Contents of Respective Components in Polyisocyanate Composition

The contents of the respective components (diisocyanate unit, monoalcohol unit and diol unit) in the polyisocyanate composition were determined from the value obtained by subtracting the diisocyanate monomer amount in (Property 6) from the feed amount of the diisocyanate and the feed amounts of the monoalcohol and the diol, on the assumption that the monoalcohol and the diol as the starting materials were completely consumed in the reaction.

### (Evaluation 1) Curability

An acrylic polyol (trade name “SETALUX1753,” manufactured by Nuplex Industries Ltd., resin component concentration: 70%, hydroxyl value: 138.6 mg KOH/g) and each of the polyisocyanate compositions were mixed in an equivalent ratio isocyanate group/hydroxyl group of 1.0, the resulting mixture was regulated with butyl acetate so as to have a solid content of 50% by mass, and thus a coating composition was obtained.

The obtained coating composition was applied to a PP plate, then cured at 23° C./50% RH for 24 hours or 48 hours; thus two different coating films were obtained, 0.2 g of each of these coating films was immersed in approximately 40 g of acetone at 20° C. for 24 hours; for each of the coating films, the ratio (% by mass) of the mass of the undissolved portion to the mass before the immersion was calculated, and the obtained value was evaluated as an index of the curability.

### (Evaluation 2) Drying Property

A coating composition obtained by the same operations as in the above-described (Evaluation 1) was applied to a glass plate so as for the film thickness to be 40 μm, and then cured at 23° C./50% RH. After the elapsed times of 5 hours and 7 hours, a cotton ball (a cylindrical form, diameter: 2.5 cm, height: 2.0 cm) was placed on the coating film, and a weight of 100 g was placed on the cotton ball for 60 seconds. Then, the weight and the cotton ball were removed, and the trace of cotton remaining on each of the coating films was observed. Thus, the drying property was evaluated according to the following five grades marked with 1 to 5: the case where the trace was not found at all was marked with 1; the case where the trace was found to remain in a small fraction was marked with 2; the case where the trace was found to remain in an amount approximately twice the trace in the case marked with 2 was marked with 3; the case where the trace was found to remain in an amount approximately twice the trace in the case marked with 3 was marked with 4; and the case where the trace was found to remain more clearly than the case marked with 4 was marked with 5.

### (Evaluation 3) Compatibility

A polyol and each of the polyisocyanate compositions were mixed in an equivalent ratio isocyanate group/hydroxyl group of 1.0, the resulting mixture was regulated with butyl acetate so as to have a solid content of 50%, and the obtained curable composition was applied to a 1-mm thick glass plate so as for the film thickness of the coating film to be 40 μm. The coated glass plate was allowed to stand still at room temperature for 30 minutes, and then allowed to stand still in an oven set at 80° C. for 30 minutes. Subsequently, the coated glass plate was cooled, the temperature of the coating film was checked to be 23° C., and then the transparency of the coating film was visually checked. The compatibility was evaluated on the basis of the following standards. “◯”: the case of being transparent; “Δ”: the case of being slightly dull; “×”: the case of being opaque. As the polyol, the following two types of polyols were used, and the cases using the respective polyols were evaluated: a fluoro-based polyol, Lumiflon (registered trademark) LF-200 (resin content concentration: 60%, hydroxyl value: 53.3 mg KOH/resin g) manufactured by Asahi Glass Co., Ltd., and an acrylic polyol, ACRYDIC (registered trademark) A-801-P (resin content concentration: 50%, hydroxyl value: 50.0 mg KOH/resin g) manufactured by DIC Corp.

### (Evaluation 4) Foundation Concealing Property

An acrylic polyol, ACRYDIC (registered trademark) A-801-P (resin content concentration: 50%, hydroxyl value: 50.0 mg KOH/resin g) manufactured by DIC Corp. and each of the polyisocyanate compositions were mixed in an equivalent ratio isocyanate group/hydroxyl group of 1.0, and the resulting mixture was regulated with butyl acetate so as for the solid content to be 50%; subsequently, to the cationic electrodeposition coating plate (black) manufactured by Standard Test Piece, Inc., the curable composition obtained by the solvent adjustment so as to have the solid content of 50% was applied with an applicator so as for the thickness of the resin film to be 40 μm. After the application, the coated plate was allowed to stand still at room temperature for 30 minutes, and then allowed to stand still in an oven set at 80° C. for 30 minutes. Subsequently, the coated plate was cooled, then the temperature of the coating film was checked to be 23° C., and then the arithmetic mean roughness Ra value was measured by using the following apparatus under the following conditions. The smaller Ra value indicates the more satisfactory foundation concealing property.

Measurement apparatus: Scanning white light interference microscope, trade name “NewView 600s,” manufactured by Zygo Corp.

Magnification factor: 2.5

Measurement method: Measurement of Ra value (arithmetic deviation from the center line)

The case where the Ra value was 0.025 μm or less was determined to have a satisfactory foundation concealing property, and thus marked with “⊚”; the case where the Ra value was more than 0.025 μm and 0.04 μm or less was determined to have a nearly satisfactory foundation concealing property, and marked with “◯”; the case where the Ra value was more than 0.04 μm was determined to have a poor foundation concealing property, and was marked with “×.”

### Example 1

The inside of a four-necked flask equipped with a stirrer, a thermometer, a reflux condenser tube and a nitrogen blowing tube was turned into a nitrogen atmosphere, and then in the four-necked flask, 600 g of HDI, 13.0 g of 1,3-butanediol as a diol, and 2.3 g of 2-ethylhexanol as a monoalcohol were fed, and a urethanization reaction was performed while the temperature inside the reactor was being maintained under stirring at 90° C. for 1.0 hour. Subsequently, the temperature inside the reactor was maintained at 80° C., 0.03 g of tetramethylammonium capriate was added as a isocyanuration catalyst, the NCO content (% by mass) of the reaction liquid was measured, and at the time when the NCO content (% by mass) came to be 33.1% (after 5.0 hours from the time when the temperature was maintained at 80° C.), phosphoric acid was added to terminate the reaction. The reaction liquid was filtered, and then the unreacted HDI was removed by using a thin film evaporation can. In 338 g of the obtained polyisocyanate composition, the solid content concentration was 99.8% by mass, the viscosity at 25° C. was 19000 mPa·s, the content of the isocyanate group was 19.2% by mass, the diisocyanate monomer concentration was 0.15% by mass, the number average molecular weight was 980, and the average number of the isocyanate group was 4.3. The molar ratio of allophanate group/(allophanate group+isocyanurate group) was 0.28, and the molar ratio of allophanate group/(allophanate group+urethane group) was 0.97. The composition of the fed starting materials, the reaction conditions and the properties of the prepared polyisocyanate composition are shown in Table 1, together with what has been described above. Also, by using the obtained polyisocyanate composition, the evaluations of the curability, the drying property, the compatibility and the foundation concealing property were performed. The evaluation results thus obtained are also shown in Table 1.

### Examples 2 to 5 and Comparative Examples 1 and 2

In each of Examples 2 to 5 and Comparative Examples 1 and 2, a polyisocyanate composition was obtained in the same manner as in Example 1 except that the composition of the fed starting materials and the reaction conditions were altered as shown in Table 1. The compositions of the fed starting materials, the reaction conditions, and the properties of the polyisocyanate compositions and the obtained evaluation results of aforementioned Examples and Comparative Examples are shown in Table 1. In Table 1, another alcohol (PL303) as a starting material in Comparative Example 3 was used in place of the monoalcohol and the diol, and was fed simultaneously with the feeding of the HDI monomer in the same manner as for the monoalcohol and the diol.

TABLE 1

| | | | | | | | Comparative | Comparative | Comparative |
|---|---|---|---|---|---|---|---|---|---|
| | | Example 1 | Example 2 | Example 3 | Example 4 | Example 5 | Example 1 | Example 2 | Example 3 |
| Diisocyanate | Type | HDI | HDI | HDI | HDI | PDI | HDI | HDI | HDI |
| | [g] | 600 | 600 | 600 | 600 | 600 | 600 | 600 | 600 |
| Diol | Type | 1,3BG | 1,3BG | 1,3BG | 1,3BG | 1,3BG | — | 1,3BG | — |
| | [g] | 13.0 | 25.0 | 25.0 | 25.0 | 38.0 | — | 43.0 | — |
| Monoalcohol | Type | 2-EHOH | 2-EHOH | 2-EHOH | i-BuOH | 2-EHOH | 2-EHOH | — | — |
| | [g] | 2.3 | 1.8 | 1.8 | 4.0 | 1.8 | 1.8 | — | — |
| Another alcohol | Type | — | — | — | — | — | — | — | PL303 |
| | [g] | — | — | — | — | — | — | — | 45.0 |
| Urethanization conditions | [° C.] | 90 | 90 | 80 | 90 | 90 | 70 | 80 | 90 |
| | [hr] | 1.0 | 1.0 | 1.0 | 1.0 | 1.0 | 1.0 | 2.0 | 1.0 |
| Isocyanuration conditions | [° C.] | 80 | 60 | 80 | 80 | 80 | 70 | 60 | 90 |
| | [hr] | 5.0 | 5.0 | 6.5 | 5.0 | 5.0 | 4.0 | 6.0 | 5.0 |
| (Property 1) Number average molecular weight | | 980 | 1010 | 990 | 990 | 880 | 590 | 990 | 1450 |
| (Property 2) Yield | [% by mass] | 55 | 55 | 58 | 54 | 54 | 25 | 60 | 47 |
| (Property 3) Isocyanate group | [% by mass] | 19.2 | 19 | 17.7 | 19.1 | 20.5 | 22.6 | 17.8 | 17.6 |
| content | | | | | | | | | |
| (Property 4) Average number of | | 4.3 | 4.6 | 4.2 | 4.5 | 4.3 | 3.2 | 4.2 | 6.1 |
| isocyanate group | | | | | | | | | |
| (Property 5) Solid content | [% by mass] | 99.8 | 99.9 | 99.8 | 99.9 | 99.8 | 99.9 | 99.8 | 99.8 |
| concentration | | | | | | | | | |
| (Property 6) Diisocyanate | [% by mass] | 0.15 | 0.13 | 0.12 | 0.13 | 0.12 | 0.20 | 0.11 | 0.13 |
| monomer concentration | | | | | | | | | |
| (Property 7) Isocyanurate trimer | [% by mass] | 25.5 | 20.6 | 25.5 | 21.3 | 18.2 | 65 | 25.7 | 21.4 |
| concentration | | | | | | | | | |
| (Property 8) Viscosity at 25° C. | [mPa · s] | 19000 | 13000 | 14000 | 12000 | 11000 | 1400 | 14000 | 20000 |
| (Property 9) Allophanate group/ | Molar ratio | 0.28 | 0.55 | 0.3 | 0.61 | 0.77 | 0.07 | 0.8 | 0.6 |
| (allophanate group + | | | | | | | | | |
| isocyanurate group) | | | | | | | | | |
| (Property 9) Allophanate group/ | Molar ratio | 0.97 | 0.98 | 0.55 | 0.98 | 0.94 | 0.99 | 0.55 | 0.99 |
| allophanate group + | | | | | | | | | |
| Urethane group) | | | | | | | | | |
| (Property 10) Contents of | Diisocyanate | 95.5 | 92.2 | 92.6 | 91.4 | 88.5 | 98.8 | 88.9 | 85.1 |
| Respective Components in | [% by mass] | | | | | | | | |
| Polyisocyanate Composition | Diol [% by | 3.8 | 7.3 | 6.9 | 7.4 | 11.0 | — | 11.1 | — |
| | mass] | | | | | | | | |
| | Monoalcohol | 0.7 | 0.5 | 0.5 | 1.2 | 0.5 | 1.2 | — | — |
| | [% by mass] | | | | | | | | |
| | Another | — | — | — | — | — | — | — | 14.9 |
| | alcohol | | | | | | | | |
| | [% by mass] | | | | | | | | |
| (Evaluation 1) Curability, | After 1 day | 81 | 82 | 78 | 79 | 80 | 71 | 77 | 83 |
| (Gel fraction) | [% by mass] | | | | | | | | |
| | After 2 days | 90 | 90 | 87 | 87 | 88 | 84 | 87 | 93 |
| | [% by mass] | | | | | | | | |
| (Evaluation 2) Drying property | After 5 hours | 3 | 3 | 4 | 3 | 4 | 5 | 4 | 3 |
| | After 7 hours | 2 | 1 | 2 | 2 | 2 | 3 | 2 | 1 |
| (Evaluation 3) Compatibility | Fluoropolyol | ◯ | ◯ | Δ | ◯ | ◯ | ◯ | Δ | X |
| | Acrylic | ◯ | ◯ | ◯ | ◯ | ◯ | ◯ | ◯ | X |
| | polyol | | | | | | | | |

| | | | | | | | | |
|---|---|---|---|---|---|---|---|---|
| (Evaluation 4) Foundation concealing property | ⊚ | ⊚ | ◯ | ⊚ | ◯ | ⊚ | X | X |

In Table 1, “HDI” represents 1,6-hexamethylene diisocyanate, “PDI” represents 1,5-pentane diisocyanate, “2-EHOH” represents 2-ethylhexanol, “i-BuOH” represents 2-methyl-1-propanol, “1,3BG” represents 1,3-butanediol, “PL303” represents Placcel 303 (trade name, manufactured by Daicel Chemical Industries, Ltd., polyester polyol, number average molecular weight: 300, the average number of the hydroxyl groups: 3.0).

### INDUSTRIAL APPLICABILITY

The polyisocyanate composition according to the present invention is useful in a wide range of fields such as vehicle repair coating materials and plastic coating materials. In particular, the achievement of the drying property and the curability at low temperatures is beneficial. The polyisocyanate composition is also useful as a clear coating material including no pigments and as a coating material excellent in acidic rain resistance and weatherability.

What is claimed is:

1. A polyisocyanate composition comprising a composition obtained at least from an aliphatic diisocyanate, a diol and a monoalcohol,
wherein an average number of an isocyanate group is 3.8 or more to 10.0 or less.

2. The polyisocyanate composition according to claim 1, wherein a molar ratio of an allophanate group to a total amount of an isocyanurate group and the allophanate group is 0.20 or more to 0.90 or less.

3. The polyisocyanate composition according to claim 1, wherein a molar ratio of an allophanate group to a total amount of a urethane group and the allophanate group is 0.60 or more to 1.00 or less.

4. The polyisocyanate composition according to claim 1, wherein the average number of the isocyanate group is 4.0 or more to 10.0 or less.

5. The polyisocyanate composition according to claim 1, wherein a viscosity at 25° C. is 8000 mPa·s or more to 50000 mPa·s or less.

6. The polyisocyanate composition according to claim 1, wherein a content of the isocyanate group is 14.0% by mass or more to 21.0% by mass or less.

7. The polyisocyanate composition according to claim 1, wherein a number of carbon atoms in the monoalcohol is 4 or more to 10 or less.

8. The polyisocyanate composition according to claim 1, wherein a molar ratio of an allophanate group to a total amount of the allophanate group and a urethane group is 0.60 or more to 1.00 or less, and the average number of the isocyanate group is 4.0 or more to 10.0 or less.

9. The polyisocyanate composition according to claim 1, wherein a molar ratio of an allophanate group to a total amount of the allophanate group and a urethane group is 0.60 or more to 1.00 or less, and a viscosity at 25° C. is 8000 mPa·s or more to 50000 mPa·s or less.

10. The polyisocyanate composition according to claim 1, wherein a molar ratio of an allophanate group to a total amount of the allophanate group and a urethane group is 0.60 or more to 1.00 or less, the average number of the isocyanate group is 4.0 or more to 10.0 or less, and a viscosity at 25° C. is 8000 mPa·s or more to 50000 mPa·s or less.

11. A coating composition comprising the polyisocyanate composition according to claim 1 and a polyol.

12. A coating method comprising a step of applying the coating composition according to claim 11 to a base coat including a pigment.
